(19) United States
(12) Patent Application Publication
(10) Pub. No.: US 2023/0408447 A1
(43) Pub. Date: Dec. 21, 2023

(54) MULTI-DIMENSIONAL RYDBERG FINGERPRINT SPECTROSCOPY

(71) Applicants: BROWN UNIVERSITY, Providence, RI (US); King Fahd University of Petroleum & Minerals, Dhahran (SA)

(72) Inventors: Peter Weber, Providence, RI (US); Joseph Geiser, Providence, RI (US); Theis Solling, Dhahran (SA); Ali A. Binabdi, Dhahran (SA)

(21) Appl. No.: 18/248,093

(22) PCT Filed: Oct. 19, 2021
(86) PCT No.: PCT/US2021/055512

§ 371 Date: Apr. 6, 2023

Related U.S. Application Data
(60) Provisional application No. 63/093,477, filed on Oct. 19, 2020.

(51) Int. Cl. G01N 27/66; G01N 21/63; G01R 29/08

(52) U.S. Cl. CPC G01N 27/66; G01R 29/0885; G01N 21/636

(57) ABSTRACT

Multi-dimensional Rydberg fingerprint spectroscopy can be used for chemical sensing in gaseous mixtures. A pulsed laser beam having a first wavelength can be delivered to a sample using a tunable pulsed excitation laser; and a pulsed laser beam having a second wavelength can be delivered to the sample point using a tunable pulsed transition laser. The pulsed laser beam having the first wavelength and the pulsed laser beam having the second wavelength have energy sufficient to excite an electron of a sample molecule to a Rydberg state. A level of ionization or light absorption can be detected at the sample point. The level of ionization or light absorption detected and the first and second wavelengths are used to determine the presence and identity of one or more chemicals in the sample of the gaseous mixture.

### CROSS-REFERENCE TO RELATED APPLICATIONS

This application claims the benefit of U.S. Provisional Application No. 63/093,477 dated 19 Oct. 2020 and entitled “CHEMICAL SENSING USING MULTI-DIMENSIONAL RYDBERG FINGERPRINT SPECTROSCOPY”, which is hereby incorporated by reference in its entirety for all purposes.

### TECHNICAL FIELD

The present disclosure relates generally to Rydberg fingerprint spectroscopy and, more specifically, to chemical sensing in multi-component mixtures, like gaseous mixtures, using multi-dimensional Rydberg fingerprint spectroscopy.

### BACKGROUND

The analysis of gaseous mixtures is of great practical importance in many areas, including medicine, environmental science, industrial processes, and the like. Hydrogen sulfide (H₂S) is an example of a gas that may be important to detect in some circumstances, like oil drilling. Natural oil deposits deep underground are highly pressurized and may include significant amounts of dissolved H₂S. When the oil is pumped to the surface, the pressure on the natural oil deposit can decrease, causing the H₂S gas to escape. Consequently, oil rig workers are potentially unknowingly exposed to harmful levels of H₂S. While the human nose is quite sensitive to H₂S, the human nose can become saturated and unable to detect the smell of H₂S after prolonged exposure, preventing oil rig workers from smelling dangerous levels of H₂S. A sensitive and real-time detector capable of monitoring the air surrounding an oil well or platform is needed to protect oil workers and ensure that their exposure to dangerous gases, such as H₂S, remains below critical levels.

Traditional approaches to analyze gaseous mixtures for dangerous gasses include mass spectrometry, gas chromatography, ion mobility spectrometry, infrared spectroscopy, hyperspectral imaging, or the like. However, these traditional approaches lack one or more of the following: sensitivity, chemical specificity, generality, ability to discern components in the presence of other components, and/or operational speed and convenience. Additionally, while Rydberg Fingerprint Spectroscopy has been proven to show optical transitions that are very specific to probed molecules, Rydberg Fingerprint Spectroscopy has not been able to analyze gaseous mixtures or other multi-component mixtures due to associated difficulties.

### SUMMARY OF THE INVENTION

The present disclosure improves traditional Rydberg Fingerprint Spectroscopy by increasing its associated dimensionality. Accordingly, multi-dimensional Rydberg Frequency Spectroscopy can be used to perform chemical sensing to detect and identify components of multi-component mixtures (such as gaseous mixtures). The systems and methods enable the real-time detection of chemicals in substantial air volumes in natural environments with high sensitivity.

A system is described that uses multidimensional Rydberg Fingerprint Spectroscopy to perform chemical sensing to detect and identify components of gaseous mixtures (a sample). The system includes at least a tunable pulsed excitation laser; a tunable pulsed transition laser; and an ionization or light absorption detector. A pulsed laser beam having a first wavelength can be delivered to a sample using the tunable pulsed excitation laser; and a pulsed laser beam having a second wavelength can be delivered to the sample point using the tunable pulsed transition laser. The pulsed laser beam having the first wavelength and the pulsed laser beam having the second wavelength have energy sufficient to excite an electron of a sample molecule to a Rydberg state. A level of ionization or light absorption can be detected at the sample point by the ionization or light absorption detector. The level of ionization or light absorption detected and the first and second wavelengths are used to determine the presence and identity of one or more chemicals in the sample.

A method is described that uses multidimensional Rydberg Fingerprint Spectroscopy to perform chemical sensing to detect and identify components of gaseous mixtures (a sample). The method includes delivering a pulsed laser beam having a first wavelength to a sample using a tunable pulsed excitation laser; and delivering a pulsed laser beam having a second wavelength to the sample point using a tunable pulsed transition laser. The pulsed laser beam having the first wavelength and the pulsed laser beam having the second wavelength have energy sufficient to excite an electron of a sample molecule to a Rydberg state. A level of ionization or light absorption can be detected at the sample point. The level of ionization or light absorption detected and the first and second wavelengths are used to determine the presence and identity of one or more chemicals in the sample.

### BRIEF DESCRIPTION OF THE DRAWINGS

The present disclosure may be more readily understood by reference to the following drawings wherein:

FIG. 1 provides a block diagram of an example system that uses multidimensional Rydberg Fingerprint Spectroscopy to perform chemical sensing to detect and identify components of a sample;

FIG. 2 provides another example of the system of FIG. 1;

FIG. 3 provides a schematic representation of the concept of the measurement: the lasers beams ionize molecules in air or other vapors; charges are accelerated to electrodes where they are measured;

FIG. 4 provides a schematic representation of excitation and ionization (as an example, a 2-photon transition to the Rydberg state is shown); and

FIG. 5 provides a process flow diagram of an example method for performing chemical sensing to detect and identify components of a sample.

### DETAILED DESCRIPTION OF THE INVENTION

### Overview

Even though spectroscopic methods are widely used to analyze substances, their applications are often limited by low sensitivity and an inability to simultaneously identify the ingredients of multi-component mixtures (e.g., gaseous mixtures). Multi-dimensional Rydberg fingerprint spectroscopy can be used for such detection and identification of components of multi-dimensional mixtures (e.g., gaseous mixtures) based on the highly structured and specific absorption spectra of molecules (e.g., when exposed to bursts of light in the vacuum ultraviolet).

Multi-dimensional Rydberg fingerprint spectroscopy can be used for chemical sensing in a sample of a multi-dimensional mixture (e.g., a gaseous mixture). A pulsed laser beam having a first wavelength can be delivered to a sample using a tunable pulsed excitation laser; and a pulsed laser beam having a second wavelength can be delivered to the sample point using a tunable pulsed transition laser. The pulsed laser beam having the first wavelength and the pulsed laser beam having the second wavelength have energy sufficient to excite an electron of a sample molecule to a Rydberg state. A level of ionization or light absorption can be detected at the sample point. The level of ionization or light absorption detected and the first and second wavelengths are used to determine the presence and identity of one or more chemicals in the sample. Taking advantage of the highly molecule-specific energies of molecular Rydberg states, the method uses multiple transition to, and between, Rydberg states to identify the one or more chemicals in the sample.

Excitation to the Rydberg states can be accomplished with 1-photon, 2-photon or higher photon processes. Transitions between Rydberg states can be similarly achieved. The systems and methods described herein advance the state of the art in several ways. First, excitation to the Rydberg states is achieved by 1-photon, 2-photon or higher photon processes. Second, additional transitions between Rydberg states provides additional dimensions of detection. Third, accelerating the charges towards electrodes for detection, where current or voltage measurement is a convenient method to measure ionization signals. And finally, identification of compounds (e.g., H₂S) is achieved by characterizing surface contours in highly dimensional space (e.g., greater than 2 dimensions).

### Definitions

Unless otherwise defined, all technical and scientific terms used herein have the same meaning as commonly understood by one of ordinary skill in the art to which this invention pertains. In case of conflict, the present specification, including definitions, will control.

The terminology as set forth herein is for description of the embodiments only and should not be construed as limiting of the invention as a whole. Unless otherwise specified, “a,” “an,” “the,” and “at least one” are used interchangeably. Furthermore, as used in the description of the invention and the appended claims, the singular forms “a”, “an”, and “the” are inclusive of their plural forms, unless contraindicated by the context surrounding such.

Also herein, the recitations of numerical ranges by endpoints include all numbers subsumed within that range (e.g., 1 to 5 includes 1, 1.5, 2, 2.75, 3, 3.80, 4, 5, etc.).

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

The terms “comprising” and variations thereof do not have a limiting meaning where these terms appear in the description and claims.

The conjunctive phrase “and/or” indicates that either or both of the items referred to can be present.

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein. In describing and claiming the present invention, the following terminology will be used.

### Systems

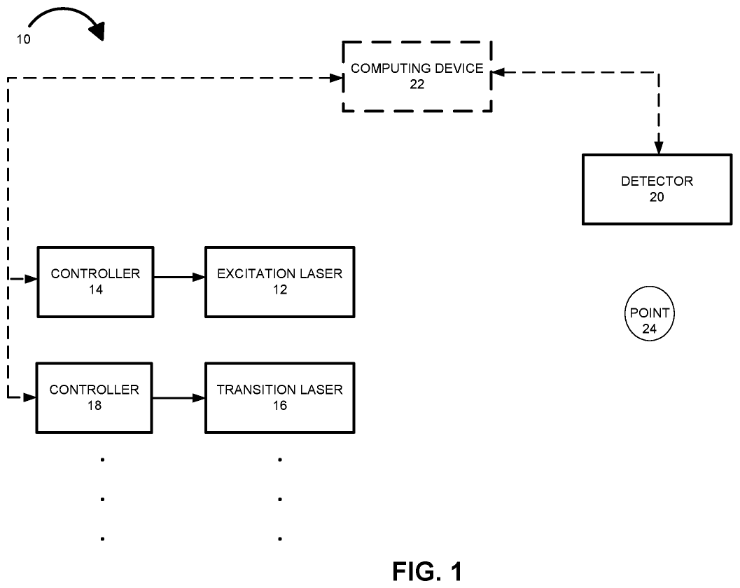

Referring now to FIG. 1, illustrated is a system 10 that uses multidimensional Rydberg Fingerprint Spectroscopy to detect and identify components of a sample. The sample can be a multi-component mixture (which may have polyatomic molecules). As an example, the multi-component mixture can be a gaseous mixture. As an example, the sample can be a gaseous mixture, like a breath sample, an air sample, or the like. The sample may include one or more chemicals, like hydrogen sulfide. In this example, the sample can be an air sample obtained from the air near an oil well. In other examples, the presence and identity of a plurality of different chemicals in the sample can be determined.

The system 10 uses multidimensional Rydberg Fingerprint Spectroscopy, which takes advantage of the concept of multiple transitions between energy levels that are highly specific identifiers of molecular states, to perform chemical sensing to detect and identify components of a sample. Notably, any type of Rydberg Fingerprint Spectroscopy detects electronic transitions in molecules. Electronic transitions in molecules are characterized by absorption cross-sections that are very large compared to vibrational transitions. Additionally, the electronic transitions are attractive for chemical sensing applications because the electronic transitions occur in UV/VIS/NIR wavelength ranges for which high power lasers and highly sensitive detectors are readily available (e.g., excitation laser 12, transition laser 16, detector 20, etc.). Rydberg Fingerprint Spectroscopy is well-suited for chemical identification, exploiting the fact that the spectra of Rydberg binding energies provide a detailed fingerprint of molecular structure that is used for the chemical identification. Rydberg Fingerprint Spectroscopy uses short (e.g., femtosecond) laser pulses to optically excite a valence electron from a neutral molecule into a Rydberg state, an excited electronic state that can be represented by a wave function resembling that of a hydrogen atom because the ionic core interaction with an excited electron can take on the general aspects of the interaction between the proton and electron in the hydrogen atom. It should be noted that the electron orbital of the Rydberg state (also referred to as the Rydberg electron orbital) need not encompass the entire molecule or cluster of molecules, as the shape of that portion that is encompassed by the Rydberg electron orbital may still be characterized in accordance with an aspect of this invention. Alternatively, the molecule or cluster of molecules may be smaller than the Rydberg electron orbital such that it is completely encompassed by the Rydberg electron orbital.

Unlike transitions between valance states, Rydberg-Rydberg and Rydberg-ion transitions reveal highly resolved and purely electronic spectra. Since Rydberg electrons do not contribute substantially to the molecular bonding, the potential energy surfaces and subsequently vibrational wavefunctions in different Rydberg states are almost identical. Vibrational wavefunctions in different Rydberg states are thus orthogonal to each other so that the Frank-Condon envelope for Rydberg-Rydberg or Rydberg-ion transitions are confined to a very narrow band. Therefore, the complexity of Rydberg spectra does not scale with the molecular size, making the technique well suited for detection of polyatomic organic molecules. Another advantage of Rydberg spectroscopy is that the number of Rydberg states in molecules mimics those of atoms.

It should further be noted that the Rydberg Fingerprint Spectroscopy approach contrasts significantly with other types of spectroscopy. IR spectroscopy, for example, provides a sensitive measure of very local regions of a molecule. The frequency of a C═O stretch vibration is determined by the force constant of the carbon-oxygen bond, which is only slightly affected by the immediate surroundings of the carbonyl group. In contrast, the Rydberg states are delocalized over very large volumes, and the energies of these states are therefore sensitive to global aspects of the molecular structure. The data derived from the measured energies of the Rydberg states may then be considered to provide a “fingerprint” of the global, large scale shape of the molecule on interest or, more succinctly, to provide a “Rydberg fingerprint”. Rydberg Fingerprint Spectroscopy allows for differentiation between different isomeric and even conformeric forms of molecules.

To detect the spatial distribution of target chemicals in a multi-component mixture, the system 10 uses a multi-photon resonant spectroscopy, multidimensional Rydberg Fingerprint Spectroscopy. Multidimensional Rydberg Fingerprint Spectroscopy rests on the concept of multiple transitions between energy levels that are highly specific identifiers of molecular states. To reach those states, which are at energies starting at about 6 eV above the molecular ground state, a two-photon excitation is used most generally, although for some compounds a one-photon excitation suffices.

Accordingly, the system 10 employs at least two lasers (excitation laser 12 and transition laser 16, but there may be additional transition lasers) that produce light with at least two different excitation wavelengths (having energy sufficient to excite an electrode of a sample molecule to a Rydberg state) and are aligned/oriented to provide the lights to a point 24 within the sample (or “sample point”). The sample point can be at any range as limited by the depletion of the laser beam due to absorption. In some embodiments, the sample point is at a range from 10 meters to 100 meters from each of the lasers (lasers do not need to be the same distance from the sample, but can be the same distance from the sample). The light produced by each of the lasers can be pulsed light to provide the photons. Moreover, the at least two lasers can be tunable. In some instances, additional parameters can be varied, including one or more Rydberg-Rydberg transition wavelength(s), pulse intensities, time delay, pulse durations of photons, pulse shape, polarization, etc. At least one of the at least two lasers can be a femtosecond laser, which may be tunable and can provide pulsed light, as an example. However, a wide variety of pulsed lasers exist that deliver pulse energies and pulse durations suited for this task.

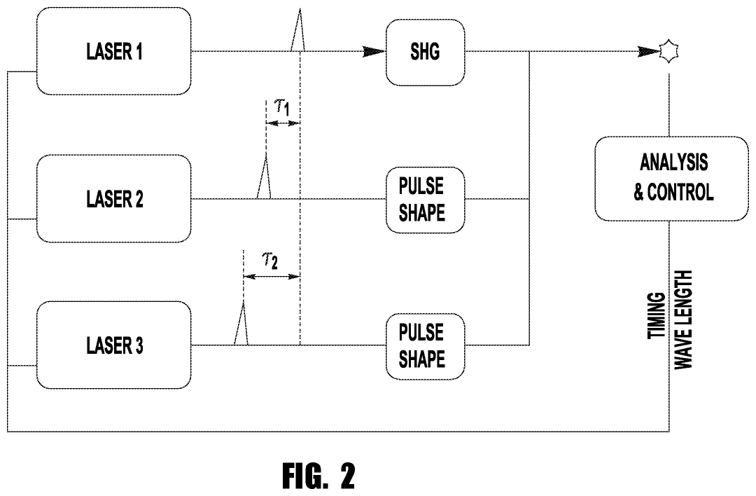

The number of lasers can each provide a dimension to the system 10. Accordingly, there is a minimum of two dimensions. A higher number of dimensions allows for more specific identification of components. Various applications may choose a higher or lower number of dimensions (with the minimum being two). For example, the system 10 can involve excitation to the sharp spectral features (e.g., with excitation laser 12 producing light with a wavelength in the vacuum ultraviolet region, between 150 nm and 200 nm) and transitions between the different spectral lines (e.g., with one or more transition laser 16 producing light with wavelengths in the visible or near IR portions of the spectrum). Scanning the wavelength of the excitation laser 12 provides one dimension. A wavelength scan of the transition laser 16 provides a second dimension. Further dimensions can be obtained by transitioning yet again to other states, with the practical limitation that each dimension requires a tunable wavelength. In this multi-dimensional space, specific but sparse peaks or shapes reveal each molecular component, offering the opportunity to identify many chemical compounds in parallel. Since the sample is at the focus of the laser beams with a volume on the order of 2-10 nl, the analysis method will work on small amounts of sample. An example use of three lasers is shown in FIG. 2. The symmetry of the molecules provides an additional parameter that enables selectivity of the process.

A detector 20 can be positioned away from the at least two lasers to perform multi-level detection, including detection of a level of ionization or light absorption at the sample point. For example, the detector 20 can be positioned proximal to the sample point. The level of ionization or light absorption detected, in addition to the wavelengths (or other information) can be utilized to determine the presence and an identity of one or more chemicals present in a sample (e.g., a multi-component mixture, such as a gaseous mixture). For example, the timing (or time delay) can be varied between the lasers so that the lights are timed to measure the kinetics of a reaction in the sample, which can indicate the presence of one or more chemicals in the sample.

As shown for example in FIG. 3, the detector can be multiple electrodes or electrical plates, like an electrometer device. Ionization creates positive and negative charges. Applying an electric field across the probe region draws these charges toward the electrodes, where they can be measured. Any of the laser beams can be modulated to detect the signal at the modulation frequency so as to enhance the specificity and sensitivity. Because the ionization with existing laser instrumentation is efficient, even low concentrations of vapors give rise to currents in the pico-Ampere range. Consequently, it is possible to measure gas components with high sensitivity (e.g., into the parts-per-billion range). Air itself is difficult to ionize because optical transitions of nitrogen, oxygen, carbon dioxide and water require more energetic photons than the molecules of interest and thus do not easily lend themselves to the present scheme. Therefore, it is possible to measure many materials with no or little background interference.

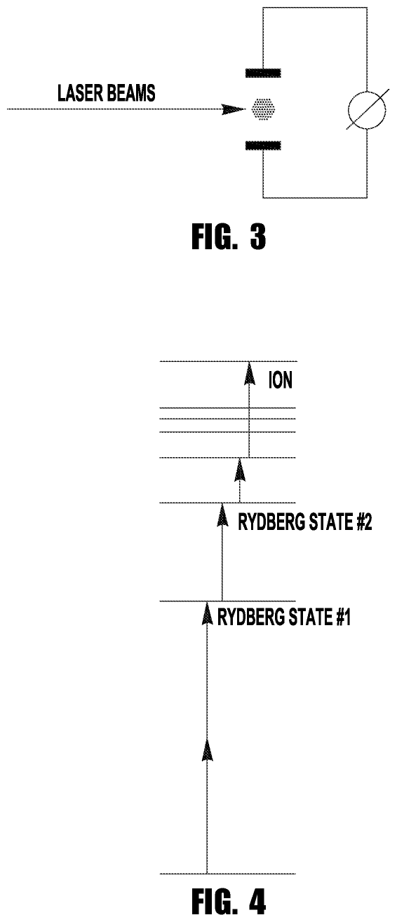

Additional selectivity is achieved from optical transition between different Rydberg states, as shown in FIG. 4. Cross sections for Rydberg-to-Rydberg transitions are large so that the efficiency of the optical transitions is high. Ionization is achieved by a final laser photon. The ionization can be out of any of the states involved in the multidimensional process, which can give rise to positive signals (or negative going signals in case of competing processes) when additional colors are present. Each laser color provides one or several dimensions for detection. Transitions between Rydberg states can be also achieved by nonlinear processes. With an appropriate tuning range of the lasers many states can be accessed. Not all the excited states need to be Rydberg states. Transitions to and from valence states may occur, depending on the molecule, and may equally be included in the multidimensional method. For example, the signal of a compound has a distinct surface in a multi-dimensional space and measuring this surface selectively and sensitively identifies specific molecular compounds, such that many compounds can be identified at the same time.

Components of the system 10 (e.g., at least the detector 20, but other instances may also include the at least two lasers and/or other components) can be employed with a self-contained sensor. An important limitation arises from the total time it takes to acquire a data set: to fully sample the entire multi-dimensional space might exceed the allowable time allocated to data acquisition. For example, the computing device 22 can store and/or execute one or more algorithms to maximize the information output. For example, a self-contained sensor could include a database with the most important features calculated at the highest possible level of theory to directly match the compound present in the analysis by direct comparison with theoretical results. Other dimensions can be included in these calculations to reduce the probability of possible mismatches.

It should be noted that the lasers (e.g., excitation laser 12 and transition laser 16 shown in FIG. 1) can include additional optical elements, like beam shaping elements, to shape the emitted beam. Moreover, and each of the lasers can be controlled by a respective controller 14, 18. In some instances, the controllers 14, 18 can be hardware devices. In other instances, the controllers 14, 18 can be software routines embedded on the computing device 22, at least in part. The computing device 22 can be connected to controller 14 and controller 18 to provide parameters for the respective laser. Additionally, the computing device 22 can be connected to the detector 20 to receive data detected and perform further analysis. The computing device can include a processor and/or a memory (which may not necessarily be separate devices). For example, the computing device 22 can be a personal computer, a laptop computer, a workstation, a computer system, an appliance, an application-specific integrated circuit (ASIC), a server, a server BladeCenter, a server farm, etc. The computing device 22 can include at least a system bus, a communication link, a processor (or processing unit), and a memory, that can be one or more non-transitory memory devices implementing at least a system memory (including a computer readable medium, a memory card, a disk drive, a compact disk (CD), a flash drive, a hard disk drive, server, standalone database, or other non-volatile memory). The processor can be, for example, embedded within one or more application specific integrated circuits (ASICs), digital signal processors (DSPs), digital signal processing devices (DSPDs), programmable logic devices (PLDs), field programmable gate arrays (FPGAs), microprocessors, other electronic units designed to perform the functions of a processor, or the like. As noted, the memory 14 can store instructions related to the one-step linear sweep-hold method. At least a portion of the instructions can be accessed by the processor 16 for execution of at least the portion of the one-step linear sweep-hold method. In its simplest form, as a first step, the processor 16 can access the memory 14 to execute the instructions to set parameter of the electrical signal (e.g., a voltage value, a timing parameter, a desired current to be produced, or the like).

An alternative system design is shown in FIG. 2. Where FIG. 1 includes minimum of two lasers, providing two spectral dimensions, FIG. 2 includes a third (optional) laser to add a further dimension. The pulses of the first laser are upconverted to the SHG before entering the sample, while the other laser pulses are pulse-shaped for added dimensionality. Pulse shaping of laser beams could involve, for example, changing the spectral bandwidth, the dispersion, or even controlling the time evolution of the electromagnetic field. All of these parameters vary the spectral signature and therefore add dimensionality to the detection space. It should be noted that the analysis/control could be one or more of the computing device 20 and/or the controllers 14, 18 of FIG. 1.

### Methods

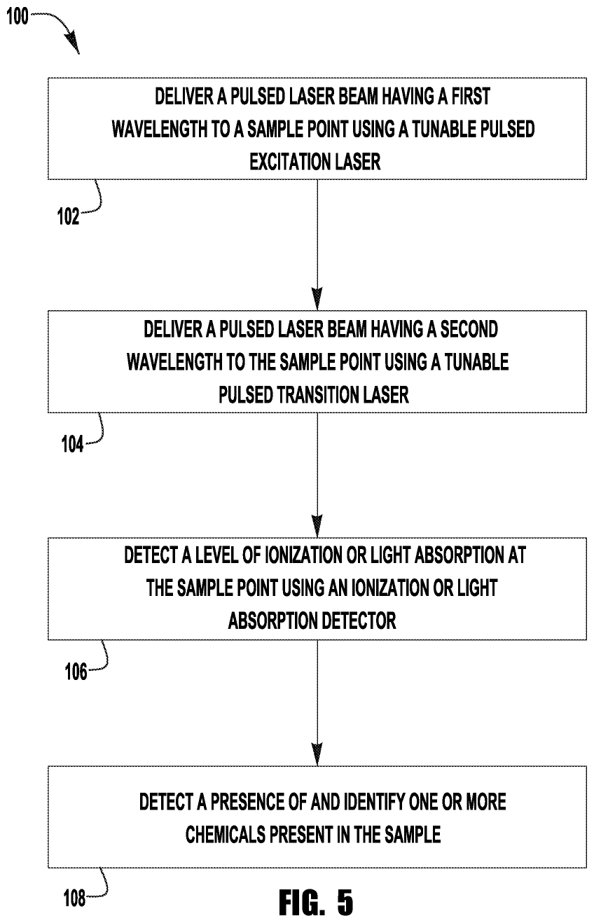

Another aspect of the present disclosure can include a method 100 (FIG. 5) that can perform chemical sensing in a multi-dimensional mixture (e.g., a gaseous mixture) using multi-dimensional Rydberg fingerprint spectroscopy. The method 100 can be executed by the systems of FIG. 1 or FIG. 2, for example. As an analytic technique, the method 100 aims to satisfy the following criteria: (1) Detect and identify substances amidst a multi-component mixture; (2) Applicable to very small sample quantities; (3) Feature a large, multi-dimensional detection space; (4) Identify substances at specific points in time.

As an example, the gaseous mixture can be a breath sample, an air sample, or the like. The sample may include one or more chemicals, like hydrogen sulfide. In this example, the sample can be an air sample obtained from the air near an oil well. In other examples, the presence and identity of a plurality of different chemicals in the sample can be determined. At 102, a pulsed laser beam having a first wavelength (e.g., the first wavelength can have a wavelength from 150 to 200 nanometers) can be delivered to a sample point (e.g., point 24) using a tunable (e.g., by computing device 22 and/or controller 14) pulsed excitation laser (e.g., excitation laser 12). At 104, a pulsed laser beam having a second wavelength (different from the first wavelength) can be delivered to the sample point (e.g., point 24) using a tunable (e.g., by computing device 22 and/or controller 18) pulsed transition laser (e.g., transition laser 16). In some instances, the wavelengths can be timed to measure the kinetics of a reaction in the sample. The pulsed laser beam having the first wavelength and the pulsed laser beam having the second wavelength have energy sufficient to excite an electron of a sample molecule to a Rydberg state (shown in FIG. 4). The tunable pulsed excitation laser and/or the tunable pulsed transition laser can be a femtosecond laser, for example. Moreover, in some instances, like that shown in FIG. 2. a plurality of pulsed laser beams, each having a different wavelength (and may, in some instances, have different durations and/or shapes), can be delivered to the sample point using a plurality of tunable pulsed transition lasers. The sample point can be at a range of from 10 meters to 100 meters from the tunable pulsed excitation laser and the tunable pulsed transition laser (and/or any additional tunable pulsed transition lasers). The distance between the additional lasers can be a common distance, but need not be a common distance.

At 106, a level of ionization or light absorption can be detected at the sample point using an ionization or light absorption detector (e.g., detector 20). The ionization or light absorption detector can be located proximal to the sample point. At 108, the level of ionization or light absorption detected, the first wavelength, and the second wavelength are used (e.g., by computer 22) to determine the presence and identity of one or more chemicals present in the sample (as described above).

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A system for multi-dimensional chemical sensing, comprising:
a tunable pulsed excitation laser aligned to deliver a laser pulse having a first wavelength to a sample point;
a tunable pulsed transition laser aligned to deliver a laser pulse having a second wavelength to the sample point,
wherein the laser pulse having the first wavelength and the laser pulse having the second wavelength have energy sufficient to excite an electron of a sample molecule to a Rydberg state; and
an ionization or light absorption detector to detect a level of ionization or light absorption at the sample point,
wherein the level of ionization or light absorption detected, the first wavelength, and the second wavelengths are used to determine a presence and an identity of one or more chemicals present in a sample.

2. The system of claim 1, wherein the tunable pulsed excitation laser and/or the tunable pulsed transition laser is a femtosecond laser.

3. The system of claim 1, wherein the system includes a plurality of tunable pulsed transition lasers, each aligned to deliver a laser pulse having a different wavelength to the sample point.

4. The system of claim 1, wherein the ionization or light absorption detector is positioned proximal to the sample point.

5. The system of claim 1, wherein the ionization or light adsorption detector is provided within an enclosed sensor device.

6. A method of multi-dimensional chemical sensing, comprising:
delivering a pulsed laser beam having a first wavelength to a sample point using a tunable pulsed excitation laser;
delivering a pulsed laser beam having a second wavelength to the sample point using a tunable pulsed transition laser;
wherein the pulsed laser beam having the first wavelength and the pulsed laser beam having the second wavelength have energy sufficient to excite an electron of a sample molecule to a Rydberg state; and
detecting a level of ionization or light absorption at the sample point using an ionization or light absorption detector,
wherein the level of ionization or light absorption detected, the first wavelength, and the second wavelength are used to determine a presence and an identity of one or more chemicals present in the sample.

7. The method of claim 6, wherein the tunable pulsed excitation laser and/or the tunable pulsed transition laser is a femtosecond laser.

8. The method of claim 6, further comprising delivering a plurality of pulsed laser beams, each having a different wavelength, to the sample point using a plurality of tunable pulsed transition lasers.

9. The method of claim 8, wherein the plurality of pulsed laser beams has different durations and/or shapes to the sample point.

10. The method of claim 6, wherein the ionization or light absorption detector is located proximal to the sample point.

11. The method of claim 6, wherein the one or more chemicals include hydrogen sulfide.

12. The method of claim 6, wherein the sample is a breath sample.

13. The method of claim 6, wherein the sample is an air sample.

14. The method of claim 13, wherein the air sample is obtained from the air near an oil well.

15. The method of claim 11, wherein the sample point is at a range of from 10 meters to 100 meters from the tunable pulsed excitation laser and the tunable pulsed transition laser.

16. The method of claim 6, where the first wavelength has a wavelength from 150 to 200 nanometers.

17. The method of claim 6, wherein the presence and identity of a plurality of different chemicals in the sample are determined.

18. The method of claim 6, wherein the pulsed laser beam having the first wavelength and the pulsed laser beam having a second wavelength are timed to measure the kinetics of a reaction in the sample.
